(19) United States
(12) Patent Application Publication
(10) Pub. No.: US 2016/0171158 A1
(43) Pub. Date: Jun. 16, 2016

(54) MEDICAL IMAGING APPARATUS AND METHOD USING COMPARISON IMAGE

(71) Applicant: SAMSUNG ELECTRONICS CO., LTD., Suwon-si (KR)

(72) Inventor: Moon Ho PARK, Hwaseong-si (KR)

(73) Assignee: SAMSUNG ELECTRONICS CO., LTD., Suwon-si (KR)

(21) Appl. No.: 14/967,884

(22) Filed: Dec. 14, 2015

(30) Foreign Application Priority Data
Dec. 12, 2014 (KR) 10-2014-0179633

(51) Int. Cl. G06F 19/00; G06F 3/0482; G06T 11/60; G06F 3/0484; G06T 7/00; G06K 9/46

(52) U.S. Cl. CPC G06F 19/321; G06T 7/0014; G06K 9/46; G06T 11/60; G06F 3/04842; G06F 3/0482; G06F 3/04847; G06T 7/003; G06F 3/04845; G06K 2009/4666; G06T 2207/20021; G06F 2203/04803; G06T 2207/30004

(57) ABSTRACT

A medical imaging apparatus may include: a reference image processor to diagnose one or more reference images acquired from one or more first views; a real-time image processor to diagnose a real-time image acquired from a second view different from the first view; and an interface component to register two or more comparison images among the one or more reference images and the real-time image, output the registered image to an interface, and process a user interaction for analyzing the two or more comparison images.

### CROSS-REFERENCE TO RELATED APPLICATION

This application claims priority from Korean Patent Application No. 10-2014-0179633, filed on Dec. 12, 2014, in the Korean Intellectual Property Office, the entire disclosure of which is incorporated herein by reference.

### BACKGROUND

1. Field

Apparatuses and methods consistent with exemplary embodiments relate to interacting with a user during a medical examination by using a real-time computer-aided design (CAD) and an interface.

2. Description of the Related Art

A medical imaging diagnostic device, such as an ultrasonic device, examines cross-sectional images that are obtained in real time. Accordingly, if a user wants to use the previously acquired cross-sectional image or the cross-sectional image of another view for diagnosis, the user evaluates, processes, and/or compares each of the stored cross-sectional images and this process greatly depends on the memory and the skill level of the medical professional. Further, since it is difficult to accurately evaluate the ultrasonic image based on only one cross-sectional image, the relevant areas with regard to the areas of interest are studied many times.

Thus, there is a need for apparatuses and methods providing the interaction between the medical device and a user for the improvement of a diagnosis convenience.

### SUMMARY

Exemplary embodiments address at least the above problems and/or disadvantages and other disadvantages not described above. The exemplary embodiments are not required to overcome the disadvantages described above, and may not overcome any of the problems described above.

In accordance with an aspect of an exemplary embodiment, a medical imaging apparatus includes: a reference image processor to diagnose one or more reference images acquired from one or more first views; a real-time image processor to diagnose a real-time image acquired from a second view different from the first view; and an interface component to register two or more comparison images among the one or more reference images and the real-time image which are acquired from at least two views, output the registered image to an interface, and process a user interaction for analyzing the two or more comparison images.

The interface component may provide a reference setting window including an option for selecting the two or more comparison images among the one or more reference images and the real-time image, register the two or more comparison images a user selects through the option, and output the registered image to the interface.

Here, the interface component may provide, to a list of selection options on the reference setting window, at least a part of the real-time image and the one or more reference images that have a same region of interest (ROI) as an ROI acquired from the real-time image.

The interface component may automatically extract the two or more comparison images based on information of ROIs detected from the one or more reference images and the real-time image, register the two or more extracted comparison images to the interface, and output the registered image to the interface.

The interface component may, in response to the user interaction, adjust and output at least one of a location, angle, and transparency of each of the two or more comparison images.

Here, the interface component may provide a reference setting window including an output option for setting at least one of an output location, angle, and transparency of each of the two or more comparison images, and adjust and output at least one of the output location, angle, and transparency of each of the two or more comparison images so as to correspond to information, which a user sets through the output option.

The interface component may output, to the interface, a diagnosis result with regard to at least a part of images among the two or more comparison images selected in response to the user interaction.

Here, the interface component may provide a reference setting window including a diagnosis result option for setting whether the diagnosis result with regard to each of the two or more comparison images is to be output, and output, to the interface, the diagnosis result with regard to the two or more comparison images that a user selects through the diagnosis result option.

Also, the interface component may output the diagnosis result with regard to the selected comparison images in response to the user interaction for selecting at least one of the two or more comparison images by using an input device including a probe, and remove, from the interface, the output diagnosis result in response to the user interaction for deselecting the comparison images, to which the diagnosis result has been output.

The interface component may, in response to the user interaction, move, rotate, remove at least one of the two or more comparison images, or add a new comparison image to the two or more comparison images.

Here, the interface component may, corresponding to an operation of, while at least one of the two or more comparison images is selected by using an input device including a probe, moving or rotating the selected comparison image to another location, move or rotate the selected comparison image.

The interface component may divide the interface into first, second, and third areas, wherein the one or more reference images are divided into the first area; the real-time image, the second area; and the two or more comparison images, the third area.

Here, the interface may: in response to the user interaction for a user to, while at least one of the images on the first and second areas is selected, move the selected image to the third area, add the selected image to the third area as a new comparison image; and in response to the user interaction for the user to, while at least one of the comparison images on the third area is selected, move the selected comparison image to the first or second area, remove the selected comparison image from the third area.

The reference image processor may include: a reference image diagnosing component to detect the ROI by diagnosing the one or more acquired reference images; and a reference image storage to store the diagnosis result of the one or more reference images.

In accordance with an aspect of an exemplary embodiment, a medical imaging method includes: diagnosing one or more reference images acquired from one or more first views; diagnosing a real-time image acquired from a second view different from the first view; registering two or more comparison images among the one or more reference images and the real-time image which are acquired from at least two views; outputting the registered image to an interface; and processing a user interaction for analyzing the two or more comparison images.

The processing of the user interaction may include: providing a reference setting window including an option for selecting the two or more comparison images among the one or more reference images and the real-time image, registering the two or more comparison images a user selects through the option, and outputting the registered image to the interface.

Here, the processing of the user interaction may include providing, to a list of selection options on the reference setting window, at least a part of the real-time image and the one or more reference images that have a same ROI as an ROI acquired from the real-time image.

The outputting of the two or more comparison images to the interface may include: automatically extracting the two or more comparison images based on information of ROIs detected from the one or more reference images and the real-time image, registering the two or more extracted comparison images, and outputting the registered image to the interface.

The processing of the user interaction may include: in response to the user interaction, adjusting and outputting at least one of a location, angle, and transparency of each of the two or more comparison images.

Also, the processing of the user interaction may include: outputting, to the interface, a diagnosis result with regard to at least a part of images among the two or more comparison images selected in response to the user interaction.

The processing of the user interaction may include: in response to the user interaction, moving, rotating, removing at least one of the two or more comparison images, or adding a new comparison image to the two or more comparison images.

The processing of the user interaction may include dividing the interface into first, second, and third areas, wherein the one or more reference images are divided into the first area; the real-time image, the second area; and the two or more comparison images, the third area.

### BRIEF DESCRIPTION OF THE DRAWINGS

The above aspects and/or other aspects will become more apparent by describing certain exemplary embodiments with reference to the accompanying drawings, in which:

FIG. 1 is a diagram illustrating a medical imaging apparatus according to an exemplary embodiment.

FIG. 2 is a detailed diagram illustrating an example of an interface component according to an exemplary embodiment.

FIG. 3 is a diagram illustrating an example of outputting a reference setting window in a medical imaging apparatus according to an exemplary embodiment.

FIG. 4A is a diagram illustrating an example of moving a comparison image in a medical imaging apparatus according to an exemplary embodiment.

FIG. 4B is a diagram illustrating an example of rotation axes that are rotatable based on an ROI in a medical imaging apparatus according to an exemplary embodiment.

FIG. 5A is a diagram illustrating an example of registering comparison images in a medical imaging apparatus according to an exemplary embodiment.

FIG. 5B is a diagram illustrating an example of registering a reference image and a real-time image and displaying the registered image on an interface according to an exemplary embodiment.

FIG. 6 is a diagram illustrating an example of setting areas, to which an image is output, in an interface of a medical imaging apparatus according to an exemplary embodiment.

FIG. 7 is a flow chart illustrating an example of a medical imaging method using a medical imaging apparatus according to an exemplary embodiment.

FIG. 8 is a flow chart illustrating an example for selecting a comparison image according to an exemplary embodiment.

FIG. 9 is a flow chart illustrating an example of receiving a user interaction and rotating a comparison image according to an exemplary embodiment.

### DETAILED DESCRIPTION

Reference will now be made in detail to embodiments, examples of which are illustrated in the accompanying drawings.

In the following description, like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

According to exemplary embodiments, a medical imaging apparatus 100 using a comparison image and a method thereof are specifically described with reference to figures.

For example, in a diagnosis using an ultrasound imaging device, during real-time ultrasonic diagnosis, a user may find a region of interest (ROI) that the user wants to observe specifically. However, when a two-dimensional (2D) ultrasonic examination is performed, a user has difficulties in confirming a diagnosis of an ROI by using only a cross-sectional image. Thus, the user tries to observe the ROI at various angles by moving a probe around the examination subject. Here, a medical imaging apparatus may support a user to observe the ROI by registering a 2D cross-sectional image to a three-dimensional (3D) cross-sectional image based on the ROI.

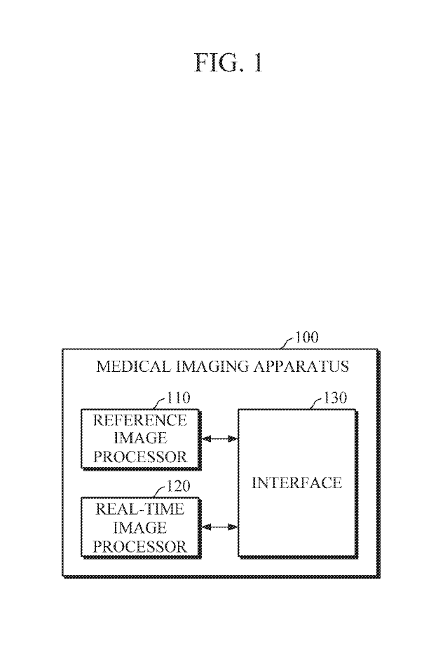

FIG. 1 is a diagram illustrating a medical imaging apparatus according to an exemplary embodiment. A medical imaging apparatus may include a reference image processor 110, a real-time image processor 120, and an interface device or interface component 130.

The reference image processor 110 diagnoses a reference image that has been acquired from one or more of first views. The reference image may be one or more images that are viewed from several directions as the location and angle with respect to one ROI are changed. Here, such specific location and angle are considered to be a view, which may indicate a specific point of view. The reference image processor 110 may acquire the reference images that are seen from various views with regard to one ROI.

The reference image processor 110 may diagnose the image of a specific point of view among images that are acquired in real time, and store such an image as the reference image. The reference image processor 110 may use at least one of the data that has been previously acquired, such as a user's previous examination record, the average data of examination subject during a time period, and the image acquired from an ultrasound examination that has been performed previously. Here, the reference image processor 110 may perform the diagnosis of the pre-acquired data as the reference image, or store the diagnosis result of the pre-acquired data as the reference image.

The reference image processor 110 may detect an ROI from the reference image and calculate a probability for the detected ROI to be benign, malignant, or a tumor. In addition, the reference image processor 110 may store the reference image and its diagnosis result in database, and generate a list of the reference images.

In addition, the real-time image processor 120 diagnoses real-time images, which are acquired from a second view that is different from the first view. Here, the first view and the second view, may be acquired differently with regard to the same ROI according to the observed location and the angle of the ROI. In the case of the real-time image, since the specific location and angle for capturing the image may be changed according to probe movement, the second view may be changed in real time.

In response to the automatic diagnosis result of the real-time images acquired from the second view, the real-time image processor 110 may extract an ROI and calculate a probability for the extracted ROI to be benign, malignant, or a tumor.

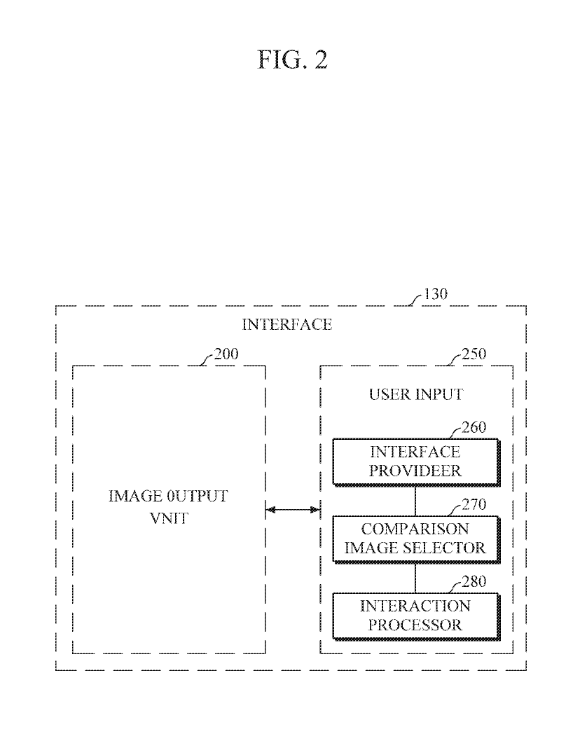

The interface component 130 registers two or more comparison images among the reference images, acquired from at least two views, and a real-time image and outputs the registered image on an interface, e.g., a monitor or display screen. Also, the interface component 130 receives interaction that is input from a user and performs a process corresponding to the interaction so as to analyze the comparison image. The interface component 130 is specifically described with reference to the detailed diagram of FIG. 2.

FIG. 2 is a detailed diagram illustrating an example of an interface component in a medical imaging apparatus 100. The interface component 130 outputs a comparison image and performs the process of interaction that is input from a user through an interface.

An interface component 130 of a medical imaging apparatus 100 may include an image output unit 200, for example, a display, and a user input 250. The user input 250 may include an interface provider 260, a comparison image selector 270, and an interaction processor 280.

The image output unit 200 may output one or more of reference images, a real-time image, and comparison images. The image output unit 200 registers at least two comparison mages among the reference images and the real-time image, both of which are acquired from at least two views, and outputs the registered image to the interface. Here, the comparison image selector 270 may select, among a plurality of images acquired from a plurality of views, images to be output as the comparison images.

The image output unit 200 may register the two or more selected comparison images based on coordinates. For example, in a case in which each of the reference images and the real-time image is a 2D cross-sectional image, the image output unit 200 may apply such a 2D image to a 3D coordinate system and register the 2D image to a 3D image so as to output the resultant 3D image. Here, the real-time image is a cross-sectional image, of which coordinates are changed by the time, and the image output unit 200 may apply the change in the coordinates of the real-time image and register the reference images and the real-time image to a 3D coordinate system so as to output the resultant 3D image.

The interface provider 260 may receive interaction that is input from a user by providing the user with an interface, for example, a graphical user interface (GUI). Here, the interface provider 260 may receive the input from a user through input devices and methods, such as a probe, a mouse, a keyboard, touching, and motion sensing.

A user may input interaction regarding the output comparison image by using the interface provider 260. There may be various examples of a user interaction for analyzing the comparison image. Among the various examples, described are only the examples, in the interaction processor 280, of performing the corresponding processes when the following inputs are received from a user: an input for a user to select the comparison image; an input for a user to adjust at least one of a location, angle, and transparency of the comparison image; an input for a user to choose whether to output a diagnosis result; and an input for a user to set, on an interface, an area to which the image is to be output.

The medical imaging apparatus 100 supports a diagnosis of an ROI, and as one example of a selection standard for a comparison image, the comparison image selector 270 may determine whether each of the ROIs is the same. The comparison image selector 270 may automatically extract two or more comparison images based on the ROI information detected from the reference images and the real-time image. For example, the comparison image selector 270 may diagnose the reference images and the real-time image, and in response to the diagnosis purpose or result, the comparison image selector 270 may automatically extract the ROI that requires a user's review. The comparison image selector 270 calculates the similarity measure between each of the ROIs, and selects the reference images that include the same ROI that shows the similarity measure greater than a threshold. Among the selected reference images, the comparison image selector 270 may select, as the comparison image, the reference image, of which view corresponds to the pre-set location and angle.

For example, the comparison image selector 270 calculates the coordinates of the real-time image, determines that the real-time image corresponds to the image of a y-z plane on a 3D coordinate system, and obtains the coordinates of the y-axis and z-axis. Here, the comparison image selector 270 may extract, as the comparison image, the reference image of which coordinates correspond to the coordinates extracted from the ROI on the real-time image. Furthermore, in a case in which a user sets an x-y plane and an x-z plane as the standard of a comparison image to be selected, the user may extract the comparison image with reference to the x-y plane and x-z plane. Of course, a user may store in advance the location and angle of the ROI on the reference image as the standard of the comparison image to be selected. In a case in which a user automatically sets the selection standard of the comparison image, a comparison image of a standardized quality may be acquired so as to objectively support the diagnosis of a user.

In another exemplary embodiment, the comparison image selector 270 may receive interaction that is input from a user so as to select the comparison image. The comparison image selector 270 may provide a user with options for selecting the comparison image on a reference setting window. Then, the user may select two or more comparison images through the interface provider 260.

For example, the comparison image selector 270 extracts an ROI, which requires a user's review in response to the diagnosis result of the real-time image, and a reference image, which has the similarity measure greater than a threshold. Here, the reference image may include an ROI, which is the same as or conforms to the ROI of the real-time image, i.e., based on the calculated similarity measure; however, the reference image may include a view, of which direction is different from the real-time image, such as the location, angle, etc. The medical imaging apparatus 100 provides, to a reference setting window, a list of reference images that include the same ROI but have the different view so as to provide a user with an option for selecting comparison images. If a user selects an image to be output as a comparison image, the interaction processor 280 may accordingly register the two or more comparison images selected by a user and output the resultant image on an interface.

When the comparison image is selected, the image output unit 200 outputs the comparison image to the interface. Here, in a case in which a user interaction is received, the interaction processor 280 performs the corresponding process.

In one exemplary embodiment, the medical imaging apparatus 100 may change the content to be output to the interface by applying the user interaction. For example, the interaction processor 280 may adjust and output at least one of the location, angle, and transparency of each comparison image according to the user interaction.

The interface provider 260 provides a user with a reference setting window that includes an output option for setting at least one of the output location, angle, and transparency of each comparison image; and if a user interaction is received, the interaction processor 280 may adjust and output at least one of the output location, angle, transparency, etc., of each comparison image so as to correspond to the information, which a user sets through the output option.

Also, the interaction processor 280 may adjust and output the location of each comparison image according to the user interaction. For example, the interface provider 260 may provide a user with a reference setting window that includes an output option for setting the output location of each comparison image. In a case in which the user sets the output location of the output option, the interaction processor 280 may adjust and output the output location and angle of each comparison image so as to correspond to the information, which the user sets through the output option.

Moreover, the interaction processor 280 may move, rotate, or remove at least one of the comparison images, or add new comparison images according to the user interaction input. In a case in which operations of rotating or moving at least one of the comparison images to another location with at least one of the comparison images being selected by a user through the interface provider 260 are input by a user, the interaction processor 280 may accordingly move or rotate the selected comparison image. For example, if while a user clicks one reference image through the interface provider 260, the user moves the selected reference image to a location, which the user wants, by using the drag and drop operational ability of the touchscreen. Here, the interaction processor 280 may receive an input from a user while interacting with the user by showing a movement path of the image that is moved through the drag and drop, and may move the selected reference image to the location corresponding to the user's input.

The interface provider 260 may receive, from a user using a probe or a touch operation as an input means, an input of an operation for moving at least one of the comparison images to another location or rotating the selected comparison image with the comparison image being selected; and the interaction processor 280 may accordingly move or rotate the selected comparison image.

Also, when the user rotates the direction of the selected image, the interface provider 260 may provide the user with rotation axes for rotating the selected image so as to make the user's input operation simple. For example, when a user clicks one reference image through the interface provider 260, the interface provider 260 may provide the user with the rotation axes of x, y, and z that are based on the ROI included in the selected reference image. The user may select one of the above-mentioned axes through the interface provider 260, and rotate the direction of the selected image by using drag and drop.

However, since the description mentioned above is just one example, the user may rotate the image that is output to the interface by selecting a real-time image or the entire registered comparison image.

The interaction processor 280 may adjust transparency of the comparison image that is displayed on the interface. The transparency of the reference image and the real-time image may be set to a preset value or separately set in response to the user interaction. For example, the interface provider 260 may receive an input of a transparency value from a user either by providing the user with an output option for setting the transparency of each comparison image on a reference setting window option, or by outputting a transparency adjustment bar of the selected image.

The interaction processor 280 may receive the interaction from a user to determine whether a diagnosis result is to be output. The interaction processor 280 may output, to the interface, a diagnosis result regarding at least a part of the images among the comparison images that have been selected according to a user interaction. For example, the interface provider 260 may provide a user with a reference setting window that includes a diagnosis result option area or window for choosing whether the diagnosis result of the reference image and the real-time image, both of which are included in the comparison image, is output. The interaction processor 280 may output the diagnosis result only for a part of the plurality of the images included in the comparison images that are output to the interface. For example, a user may choose to output a diagnosis result only for the part of the comparison images. In a case in which a user chooses to output a diagnosis result only for a real-time image through a reference setting window, the interaction processor 280 may output the diagnosis result only for the real-time image among the comparison images. Here, the diagnosis result may be a probability for the ROI, detected from the real-time image, to be benign, malignant, or a tumor, etc.

As one example of an input device, the interface provider 260 may use a button equipped on a probe. If a user chooses whether a diagnosis result is shown or not (on/off) using the button on the probe, the medical imaging apparatus 100 may output the diagnosis result to the interface by applying the user's selection.

In another example, the interface provider 260 may use a touch operation. In a case in which a viewable display is configured with a touchscreen, the interaction processor 280 may, in response to a user's touch operation, choose the on/off operation of the interface regarding whether the diagnosis result is to be output.

Generally, an ultrasonic device intensively examines a part, which is determined to be an ROI, as overall scanning the part to be examined. The interaction processor 280 may turn on or off whether the diagnosis result is output through the simple touching or button control during an ultrasound examination. Thus, when an examination is performed in real time, the diagnosis result of a part required for the intensive review may be output, which can be convenient for a user.

The interaction processor 280 may set an area of the image to be output to an interface after receiving a user interaction. For example, the interface provider 260 may receive, from a user, an input of dividing the area of the interface. The user may input, through the interface provider 260, operations of performing the settings for outputting a reference image to a first area, a real-time to a second area, and a comparison image to a third area. Furthermore, the user may set a fourth area for enlarging and outputting only the ROI of the comparison image.

In a case in which the interface provider 260 sets each of the areas that are output to the interface as above, the interface provider 260 may receive a user interaction through the set areas. In a case in which the medical imaging apparatus 100 is set to output a reference image to the first area, a real-time image to the second area, and a comparison image to the third area, if a user clicks the reference image, which is output to the first area through the interface provider 260, and drags and drops the reference image onto the third area, the interaction processor 280 may add the reference image which has been moved to the comparison image using the drag and drop. Also, if a user clicks the part of the reference image in the comparison image on the third area and drags and drops the part to the first area, the interaction processor 280 may remove, from the comparison image, the reference image which has been moved using the drag and drop. The same operation may be performed with regard to the second area. Setting an area, to which an image is output, to use the area as an interface may increase a user's convenience in selecting and moving an image.

There may be various exemplary embodiments of the interaction processor 280 that interacts with a user, and the examples described herein are not limiting. The exemplary embodiments may be implemented by various user experience (UX) designs.

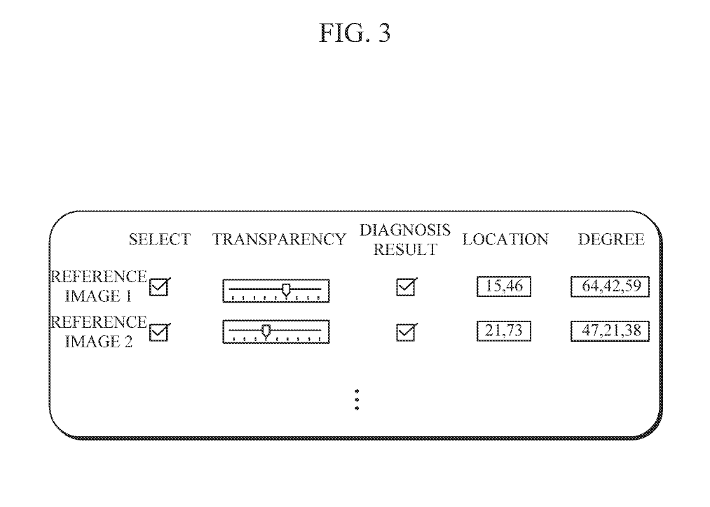

FIG. 3 is a diagram illustrating an example of outputting a reference setting window in a medical imaging apparatus 100. The reference setting window may include an option for selecting a comparison image and an output option area, e.g., screen area, for adjusting at least one output of: a location of an image; an angle of the image; and a transparency degree or rate of the image. Also, the reference setting window may include a diagnosis result option area, e.g., screen area, for setting whether the diagnosis result is output. There may be other various exemplary embodiments for interacting with a user through an interface output on a screen.

The medical imaging apparatus 100 may output, to a viewable display, an input window as illustrated in FIG. 3. Referring to FIG. 3, the reference setting window may include an option screen area for selecting a comparison image. The interface of the medical imaging apparatus 100 may provide a user with a list of the reference images that are selectable on the reference setting window. A user selects the comparison image to be output, and the medical imaging apparatus 100 may register and output the two or more comparison images that are selected by the user.

In addition, a user may adjust the transparency degree of each image by using the output option on the reference setting window. With reference to FIG. 3, setting the adjustment window of the transparency which indicates a low transparent value on the left side and a high transparent value on the right side, the reference image 1 has higher transparency than the reference image 2, which has lower transparency than the reference image 1. Accordingly, when the reference image is output to the display, the reference image 1 is output to be more transparent compared to the reference image 2.

The reference setting window may receive an input from a user to move the location of the image. Referring to FIG. 3, the location of the reference image 1 is on (15, 46), and its angle is 64°, 42°, and 59°. The location of the reference image 2 is on (21, 73), and its angle is 47°, 21°, and 28°. The locations of the reference images 1 and 2 indicate coordinates of a 2D image or a 3D image, respectively. The location and angle of the reference image may be automatically calculated in a computer-aided design (CAD) software or a device supported by CAD software. The medical imaging apparatus 100 may register a cross-sectional image to a 3D coordinates (x-axis, y-axis, and z-axis) using information on the location and angle of the image and output the comparison image.

Here, a user may input an interaction that changes the location or angle of each image through a reference setting window. For example, if a user changes the x-axis angle of the reference image 1 from 64° to 60°, the medical imaging apparatus 100 may output the reference image 1, which is acquired after the reference image 1 has been rotated −4° around the x-axis, by applying such a change.

In addition, the medical imaging apparatus 100 may provide a diagnosis result option for setting, through the reference setting window, whether the diagnosis result is output. Whether the diagnosis result is output may be set for each of the image, separately. FIG. 3 illustrates a reference setting window in which the diagnosis results of the reference images 1 and 2 are set to be output.

The medical imaging apparatus may output the reference setting window to be divided into each of the windows for a selection option, an output option, and a diagnosis result option windows, which may be output after receiving a user interaction. Also, since there may be various exemplary embodiments of the reference setting window including the output content and the configuration of the interface, the scope of the present disclosure is not limited to the exemplary embodiments mentioned above.

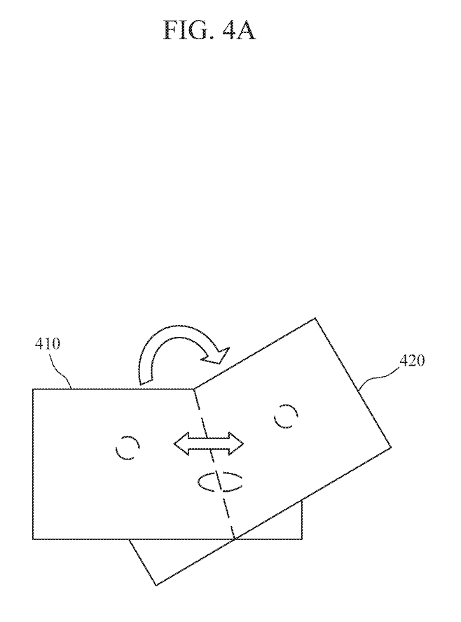

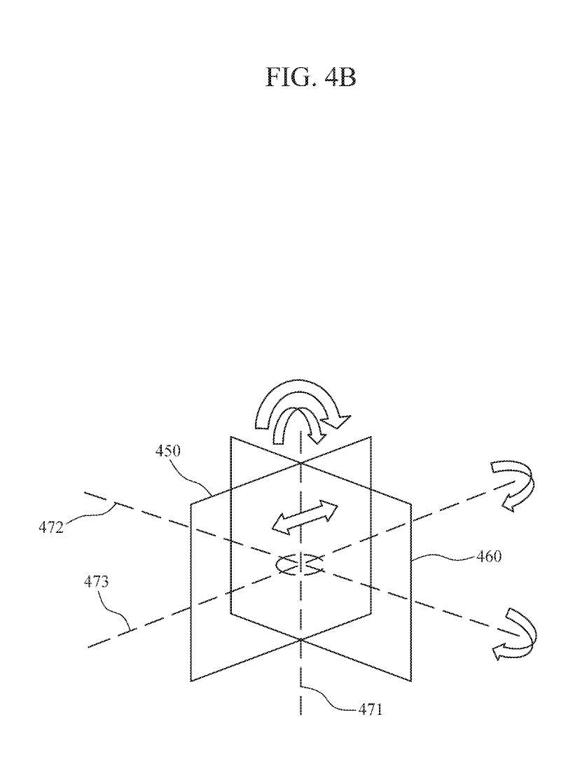

FIG. 4A is a diagram illustrating an example of moving a comparison image in a medical imaging apparatus 100. A user may move the comparison image to review an ROI of the comparison image at various angles. The medical imaging apparatus 100 moves the comparison image corresponding to the user interaction.

A user clicks a comparison image 410 through an interface. A user may move the comparison image 410 in a direction of an arrow by using rotation axes that are based on an ROI of the comparison image 410. A comparison image 420 after the movement may have a changed angle but include all of the two ROIs of circle and oval shapes, which have been included in the comparison image 410 before the movement.

In a case in which the transparency of the comparison image is too high to identify the cross section, the direction of the cross section may be shown in a form of an arrow that is a straight line as illustrated in FIG. 4A.

FIG. 4B is a diagram illustrating an example of rotation axes that are rotatable based on an ROI in a medical imaging apparatus 100. An interface of the medical imaging apparatus 100 may provide rotation axes to a user so as to increase a user's convenience for the input.

In a case in which a user clicks a part of a comparison image through an interface, the medical imaging apparatus 100 may output, to an interface, the rotation axes that are based on the ROI that is included in the clicked image. For example, the medical imaging apparatus 100 may diagnose the comparison image to support a diagnosis of the ROI, detect the ROI, and find a center point of the ROI. The interface may output the rotation axes of x, y, and z on a basis of the center of the ROI. Accordingly, a user is capable of rotating the clicked image by selecting and dragging-and-dropping one of the three rotation axes, which have been output to the interface.

Referring to FIG. 4B, a comparison image 450 exists on the z axis 473. Here, the direction of the comparison image 450 may be shown along with a straight arrow to the interface. For example, when a user clicks the comparison image 450 through the interface component, the medical imaging apparatus 100 may mark the direction of the cross section of the clicked comparison image by using a straight arrow and output the rotation axes of x, y, and z 471, 472, and 473, which are based on the ROI of the comparison image 450, through the interface, as illustrated in FIG. 4B. Accordingly, a user may select the x axis 471 and drag-and-drop the comparison image 450 in a direction of the arrow. The medical imaging apparatus 100 may move the clicked image in response to the user interaction.

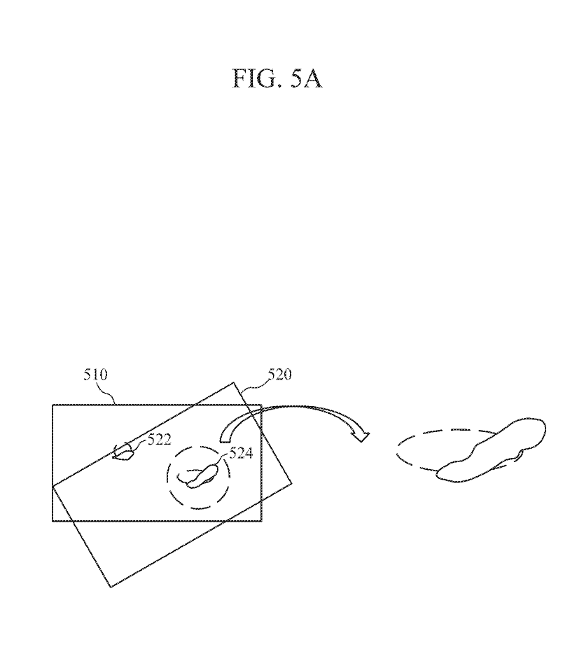

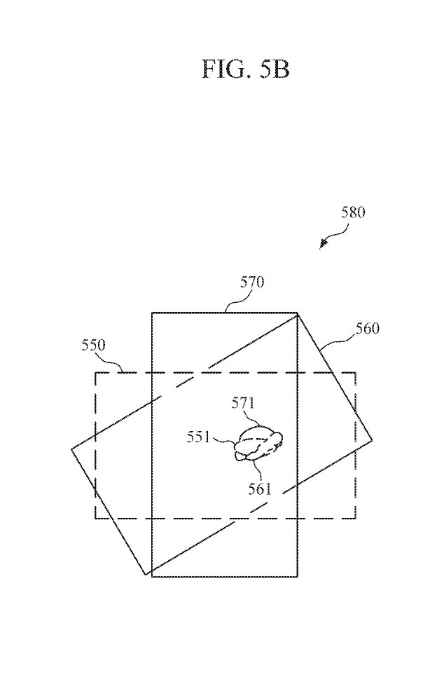

FIG. 5A is a diagram illustrating an example of registering two comparison images in a medical imaging apparatus. The diagnosis may register and output two or more comparison images. Here, in the case in which the medical imaging apparatus 100 registers a plurality of comparison images, which includes the same ROI, but of which one or more of the location and angle are different from each other, the ROIs may be displayed to be overlapped.

Referring to FIG. 5A, a comparison image 1 510 includes two ROIs of a circular shape 522 and an oval shape 524. In addition, a similarity of a comparison image 2 520 and the ROI of the comparison image 1 is more than a threshold, so that they are determined to be the same but have two ROIs of the views different from one another. The medical imaging apparatus 100 may register the comparison image 1 510, acquired from the first view, and the comparison image 2 520, acquired from the second view. Here, the medical imaging apparatus 100 may output the comparison images of which the transparency has been differently changed, respectively. In the medical imaging apparatus 100, the transparency may be automatically adjusted according to a preset value or individually adjusted through a user interaction.

In FIG. 5A, the medical imaging apparatus 100 sets the transparency of the comparison image 1 510 to be high, which is illustrated in a dotted line. Also, compared to the comparison image 1, the comparison image 2 520 may be more clearly output in the medical imaging apparatus 100, which is illustrated in a solid line.

The right figure in FIG. 5A is the enlarged image of the primary ROI. According to the diagnosis result of the comparison images, one or more ROIs may be detected. According to the diagnosis result of the probability for each ROI to be benign, malignant, or a tumor, the ROI, which requires more reviews for the support of the user's diagnosis, may be extracted. In addition, according to the diagnosis result of the comparison images, the medical imaging apparatus 100 may enlarge the ROI that requires the review, which is then output.

Even though the reference image with the same ROI is registered automatically as the comparison image, the result indicating that each ROI is not overlapped may occur. In such a case, a user may move the comparison images so that each ROI of the two or more comparison images may be overlapped and then displayed. Here, the medical imaging apparatus 100 may output, to an interface, the overlap degree of the ROI between the comparison images and guide a user to move the image so as to increase the overlap degree of the ROI.

FIG. 5B is a diagram illustrating an example of registering a reference image and a real-time image as a comparison image and displaying the registered image on an interface. The medical imaging apparatus 100 may register and output, to the interface, a plurality of comparison images. For example, the medical imaging apparatus 100 may output a reference image 1 550, a reference image 2 560, and a real-time image 570 to the interface as comparison images, and diagnose the ROIs of the comparison images. In FIG. 5B, the real-time image is illustrated as the cross-sectional image of a specific point of view for convenience of description, but since a real-time image 570 is the image being collected in real time, the output of the comparison image on the interface may continuously change.

The medical imaging apparatus 100 may output the ROIs to be overlapped. Here, the medical imaging apparatus 100 may adjust the transparency of each image and output each image to be distinguished from each other. Referring to FIG. 5B, an ROI 551 of a reference image 1 550 is shown in a dotted line; and an ROI 561 of a reference image 2 560 is shown in a dot-dash line. In the case the medical imaging apparatus 100 outputs the ROIs, the ROIs 551, 561, and 571 may be output corresponding to the transparency of each of the images 550, 560, and 570.

In another exemplary embodiment, the medical imaging apparatus 100 may set the transparency of the reference images 550 and 560 to be high so as to display them blurred, but if in response to the diagnosis result of the reference images, the medical imaging apparatus 100 may extract at least one of the ROIs 551 and 561, which requires the review; and with regard to the extracted ROIs 551 and 561, set the transparency to be lower than the reference images 550 and 560. In such a case, the medical imaging apparatus 100 may display the reference images 550 and 560 to be transparent; the ROIs 551 and 561, included in the reference images 550 and 560, to be relatively clearer than the reference images 550 and 560; and the real-time image 570 to be clear.

The medical imaging apparatus 100 may register a plurality of the comparison images 550, 560, and 570, and overlap the ROIs thereof to be then displayed. Generally, information to be output to the 3D image may be not sufficient in an operation of registering a 2D cross-sectional image to a 3D image. To supplement such insufficient information, the medical imaging apparatus 100 may acquire information on the ROI of a 3D form by adding, as the comparison images, the images, which are collected after the location and direction with regard to the same ROI have been changed. FIG. 5B illustrates registering the two reference images 550 and 560 and the real-time image 570 as the comparison image 580, and further more images may be added as the comparison images. Also, a user may move or rotate the part or entirety of the comparison image in the desired direction by inputting the interaction thereof through the interface of the medical imaging apparatus 100.

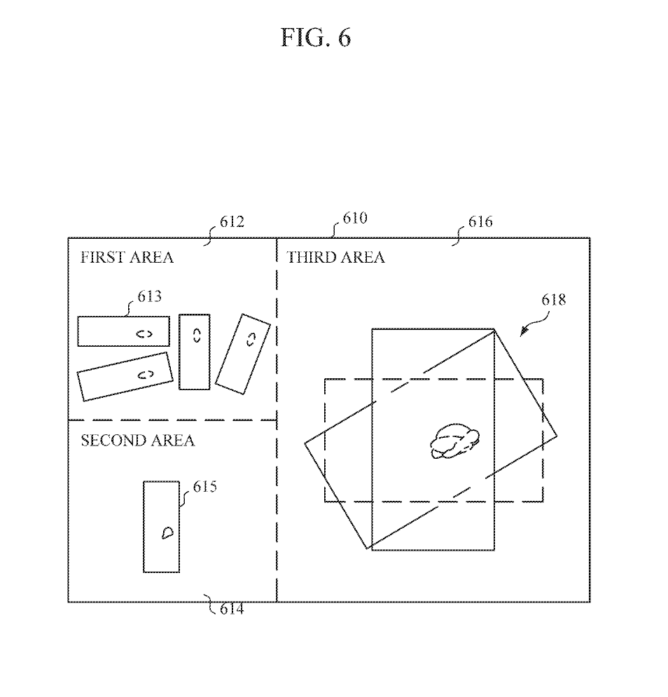

FIG. 6 is a diagram illustrating an example of setting areas, to which each image is output, in an interface of a medical imaging apparatus.

Using a medical imaging apparatus 100, an area, to which each image is output, on an interface 610 may be set. Referring to FIG. 6, by using the medical imaging apparatus 100, a first area 612 is set to output one or more reference images 613; a second area 614 is set to output a real-time image 615; and a third area 616 is set to output a combined comparison image 618 including at least two images among the reference images and the real time image.

In an exemplary embodiment, if while clicking the reference image that is output to the first area through the interface, a user drags and drops it to the third area, the reference image may be added to one or more comparison images in the medical imaging apparatus 100. Also, if while clicking the part of the reference image within the comparison images in the third area, a user drags and drops it to the first area, the reference image coming out of the comparison images through the drag-and-drop may be removed therefrom in the medical imaging apparatus 100. With regard to the second area, the same operation as mentioned above may be performed. In addition, the medical imaging apparatus 100 may display visual movement effects on the interface, such as the operation of when a user inputs the drag-and-drop, outputting the movement trace corresponding to the user's input. If an area with respect to the image to be output is set and then used as an interface, the user's convenience may be increased in selecting and moving the images.

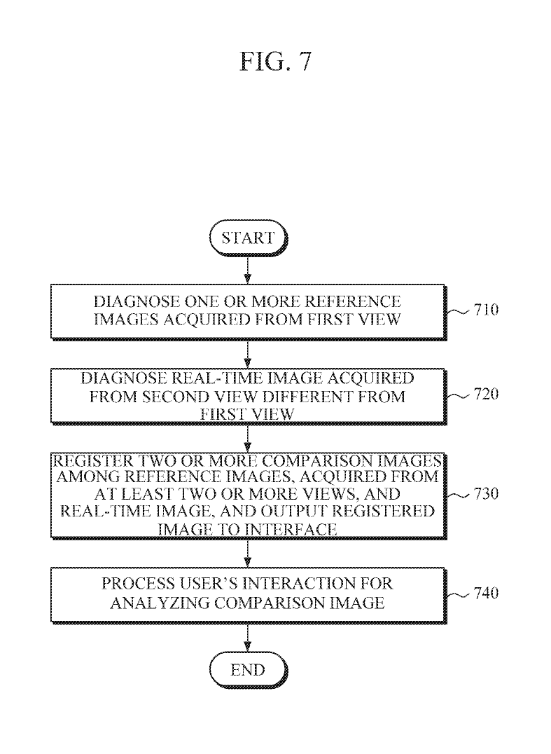

FIG. 7 is a flow chart illustrating an example of a medical imaging method using a medical imaging apparatus.

First, a medical imaging apparatus 100 diagnoses a reference image that has been acquired from a first view in operation 710.

The reference image may be one or more images that are viewed from several directions as the location and angle with respect to one ROI are changed. Here, such specific location and angle are considered to be a view, which may indicate a specific point of view. The medical imaging apparatus 100 may acquire the reference images that are seen from various views with regard to one ROI.

The medical imaging apparatus 100 may diagnose the image of a specific point of view among images that are acquired in real time, and store such an image as the reference image. The medical imaging apparatus 100 may use at least one of the data that has been previously acquired, such as a user's previous examination record, the average data of examination subject during a time period, and the image acquired from an ultrasound examination that has been performed previously. Here, the medical imaging apparatus 100 may perform the diagnosis of the pre-acquired data or store the diagnosis result of the pre-acquired data as the reference image.

The medical imaging apparatus 100 may detect an ROI from the reference image and calculate a probability for the detected ROI to be benign, malignant, or a tumor. In addition, the reference image processor 110 may store the reference image and its diagnosis result in database, and generate a list of the reference images.

Then, the medical imaging apparatus 100 diagnoses real-time images, which are acquired from a second view that is different from the first view in operation 720. Here, the medical imaging apparatus 100 diagnoses the real-time images, which are acquired from the second view that is different from the first view. Here, the first view and the second view, may be acquired differently with regard to the same ROI according to the observed location and the angle of the ROI. In the case of the real-time image, since the specific location and angle for capturing the image may be changed according to probe movement, the second view may be changed in real time.

In response to the automatic diagnosis result of the real-time images acquired from the second view, the medical imaging apparatus 100 may extract an ROI and calculate a probability for the extracted ROI to be benign, malignant, or a tumor.

Then, the medical imaging apparatus 100 registers and outputs, to an interface, two or more comparison images among the reference images, acquired from at least two views, and a real-time image in operation 730.

The medical imaging apparatus 100 may register the two or more comparison images based on coordinates. For example, in a case in which each of the reference images and the real-time image is a 2D cross-sectional image, the medical imaging apparatus 100 may apply such a 2D image to a 3D coordinate system and register the 2D image to a 3D image so as to output the resultant 3D image. Here, the real-time image is a cross-sectional image, of which coordinates are changed by the time, and the image output unit 200 may apply the change in the coordinates of the real-time image and register the reference images and the real-time image to a 3D coordinate system so as to output the resultant 3D image.

Then, the medical imaging apparatus 100 may process a user interaction for analyzing the comparison images in operation 740. A user may input the interaction with respect to the output comparison images by using an interface. There may be various examples of a user interaction for analyzing the comparison images. Among the various examples, described are only the examples, in the medical imaging apparatus 100, of performing the corresponding processes when the following inputs are received from a user: an input for a user to select the comparison image; an input for a user to adjust at least one of a location, angle, and transparency of the comparison image; an input for a user to choose whether to output a diagnosis result; and an input for a user to set an area to which the image is to be output.

The medical imaging apparatus 100 supports a diagnosis of an ROI, and as one example of a selection standard for a comparison image, whether each of the ROIs is the same may be used. The medical imaging apparatus 100 may automatically extract two or more comparison images based on the ROI information detected from the reference images and the real-time image. For example, the medical imaging apparatus 100 may diagnose the reference images and the real-time image, and in response to the diagnosis result, the medical imaging apparatus 100 may automatically extract the ROI that requires a user's review. The medical imaging apparatus 100 calculates the similarity measure between each of the ROIs, and selects the reference images that include the same ROI that shows the similarity measure greater than a threshold. Among the selected reference images, the medical imaging apparatus 100 may select, as the comparison image, the reference image, which has the view corresponding to the pre-set location and angle. In a case in which a user sets the selection standard of the comparison image to be automatic, the medical imaging apparatus 100 may acquire the comparison image having the standardized quality so as to support a user's diagnosis objectively.

In another exemplary embodiment, the medical imaging apparatus 100 may receive interaction that is input from a user so as to select the comparison image. The medical imaging apparatus 100 may provide a user with an option for selecting the comparison image on a reference setting window. Then, the user may select two or more comparison images through the interface of the medical imaging apparatus 100.

For example, the medical imaging apparatus 100 extracts an ROI, which requires a user's review in response to the diagnosis result of the real-time image, and a reference image, of which similarity measure is greater than a threshold. Here, the reference image may include an ROI, which is the same as or conforms to the ROI of the real-time image; however, the reference image may include the different direction from the real-time image, such as the location, angle thereof. The medical imaging apparatus 100 provides, to a reference setting window, a list of reference images that include the same ROI but have the different view so as to provide a user with an option for selecting comparison images. If a user selects an image to be output as a comparison image, the medical imaging apparatus 100 may accordingly register the two or more comparison images selected by a user and output the resultant image on an interface.

When the comparison images are selected, the medical imaging apparatus 100 outputs the comparison images to the interface. Here, in a case in which a user interaction is received, the medical imaging apparatus 100 performs the corresponding process.

In one exemplary embodiment, the medical imaging apparatus 100 may adjust and output at least one of the location, angle, and transparency of each comparison image according to the user interaction.

The medical imaging apparatus 100 provides a user with a reference setting window that includes an output option for setting at least one of the output location, angle, and transparency of each comparison image; receive a user interaction; and adjust and output at least one of the output location, angle, transparency, etc., of each comparison image so as to correspond to the information, which a user sets through the output option.

Also, the medical imaging apparatus 100 may adjust and output the location of each comparison image according to the user interaction. In a case in which the user sets the output location on the output option through the reference setting window, the medical imaging apparatus 100 may adjust and output the output location and angle of each comparison image so as to correspond to the information, which the user sets through the output option.

Moreover, the medical imaging apparatus 100 may move, rotate, or remove at least one of the comparison images, or add new comparison images according to the user interaction.

The interface may use, as an input device, a probe or a touch operation. In a case in which operations of rotating or moving at least one of the comparison images to another location with at least one of the comparison images being selected by a user through the interface provider 260 are input by a user, the medical imaging apparatus 100 may accordingly move or rotate the selected comparison image.

For example, if while a user clicks one reference image through the interface, the user moves the selected reference image to a location, which the user wants, by using the drag and drop. Here, the medical imaging apparatus 100 may receive an input from a user while interacting with the user by showing a movement path of the image that is moved through the drag and drop, and may move the selected reference image to the location corresponding to the user's input.

Also, when the user rotates the direction of the selected image, the interface may provide the user with rotation axes for rotating the selected image so as to make the user's input operation simple. For example, when a user clicks one reference image through the interface, the interface provider 260 may provide the user with the rotation axes of x, y, and z that are based on the ROI included in the selected reference image. The user may select one of the above-mentioned axes through the interface, and rotate the direction of the selected image by using drag and drop.

The medical imaging apparatus 100 may adjust transparency of the comparison image that is displayed on the interface. The transparency of the reference image and the real-time image may be set to a preset value or separately set in response to the user interaction. For example, the medical imaging apparatus 100 may receive an input of a transparency value from a user either by providing the user with an output option for setting, on a reference setting window, the transparency of each comparison image or by outputting a transparency adjustment bar of the selected image.

The medical imaging apparatus 100 may receive the interaction from a user to determine whether a diagnosis result is to be output. The medical imaging apparatus 100 may output, to the interface, a diagnosis result regarding at least a part of the images among the selected comparison images. For example, the medical imaging apparatus 100 may provide a user with a standard setting window including a diagnosis result option for interacting with a user, or separately receive the selection from a user, who clicks the image that has been output to the interface, to determine whether the diagnosis result is to be output.

For one example of an input device, the medical imaging apparatus 100 may use a button equipped on a probe. If a user chooses whether a diagnosis result is shown or not (on/off) using the button on the probe, the medical imaging apparatus 100 may output the diagnosis result to the interface by applying the user's selection.

In another example for an input device, the medical imaging apparatus 100 may use a touch operation of an interface. In a case in which an interface is formed with a touchscreen, the medical imaging apparatus 100 may, in response to a user's touch operation, choose the on/off operation of the interface regarding whether the diagnosis result is to be output.

Generally, an ultrasonic device intensively examines a part, which is determined to be an ROI, as overall scanning the part to be examined. Here, the operation for overall scanning the part to be examined may not include the operation of outputting the diagnosis result, and the medical imaging apparatus 100 may provide a user with a customized support to perform the more intensive examination by outputting the diagnosis result only to a part that, as a user determines, requires the review.

The medical imaging apparatus 100 may set an area of the image to be output to an interface after receiving a user interaction. For example, the medical imaging apparatus 100 may receive, from a user, an input of dividing the area of the interface. The user may input, through the medical imaging apparatus 100, operations of performing the settings for outputting a reference image to a first area, a real-time to a second area, and a comparison image to a third area. Furthermore, the user may set a fourth area for enlarging and outputting only the ROI of the comparison image.

Beyond the above-mentioned exemplary embodiments, there may be various exemplary embodiments for the medical imaging apparatus 100 that interacts with a user by using comparison images. Thus, the present disclosure is not limited to the above-mentioned exemplary embodiments.

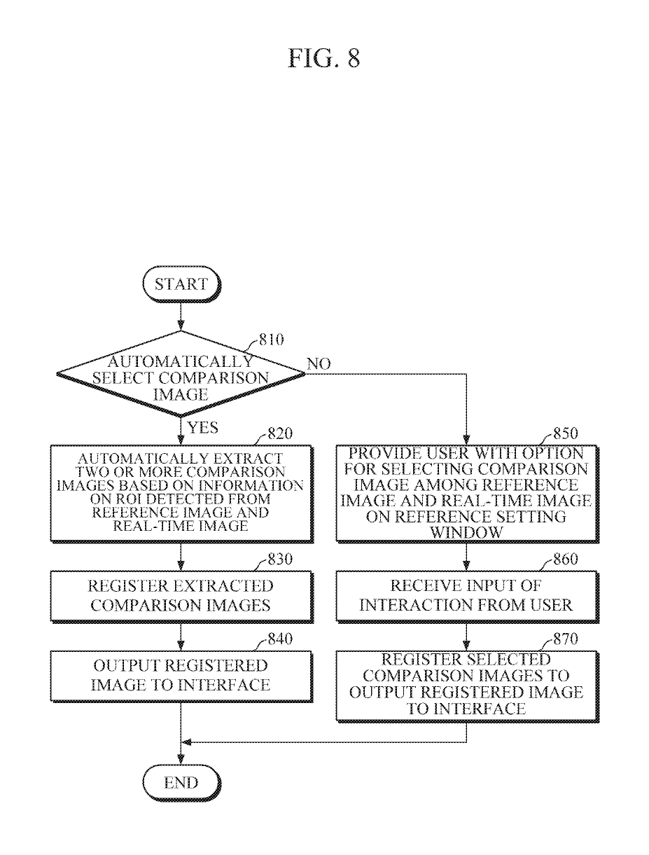

FIG. 8 is a flowchart illustrating an example for selecting a comparison image by using a medical imaging apparatus 100. In one exemplary embodiment, a medical imaging apparatus 100 may automatically extract a comparison image and select the comparison image by selecting the comparison image or receiving an input of a user interaction.

First, the medical imaging apparatus 100 determines whether to automatically select the comparison image in operation 810. The medical imaging apparatus 100 may automatically select the comparison image if there is no user interaction.

Then, the medical imaging apparatus 100 may automatically extract the two or more comparison images based on the ROI, which has been detected from a reference image and a real-time image in operation 820.

For example, the medical imaging apparatus 100 may calculate the coordinates of the real-time image, determine that the real-time image corresponds to the image of a y-z plane on a 3D coordinate system, and in response to the diagnosis result of the real-time image, obtain the coordinates of the y-axis and z-axis of the ROI. Here, the medical imaging apparatus 100 may extract, as the comparison image, the reference image of which coordinates correspond to the coordinates of the y-axis and z-axis of the ROI on the real-time image. Furthermore, in a case in which a user sets an x-y plane and an x-z plane as the standard of a comparison image to be selected, the user may extract the comparison image with reference to the x-y plane and x-z plane. Of course, a user may store in advance the location and angle of the ROI on the reference image as the standard of the comparison image to be selected. In a case in which a user automatically sets the selection standard of the comparison image, a comparison image of a standardized quality may be acquired so as to support the diagnosis of a user.

Then, the medical imaging apparatus 100 registers the two or more extracted comparison images in operation 830 and then output the registered image to an interface in operation 840.

Alternatively, in a case in which the medical imaging apparatus 100 receives a user interaction, the medical imaging apparatus 100 may select the comparison image that corresponds to the user interaction in operation 810. The medical imaging apparatus 100 may provide an option for selecting, on a reference setting window, the comparison image among the reference images and the real-time image. For example, the medical imaging apparatus 100 may extract the reference image, of which similarity measure is greater than a threshold compared to the ROI that requires a user's review in response to the diagnosis result of the real-time image. Here, the reference image may include the ROI, which conforms to the ROI of the real-time image; however, the reference image may include the different direction from the real-time image, such as the location, angle. The medical imaging apparatus 100 may provide the reference setting window with a list of the reference images so as to provide a user with the option for selecting the comparison images.

Next, the medical imaging apparatus 100 may receive, from a user, the interaction for selecting the comparison image through the interface thereof in operation 860. Then, the medical imaging apparatus 100 may register and output, to the interface, the selected comparison images in operation 870.

Even though only the exemplary embodiments of receiving an input of a user interaction through a reference setting window of the medical imaging apparatus 100 have been described above, this is not limiting, and there may be various exemplary embodiments thereof for selecting a comparison image.

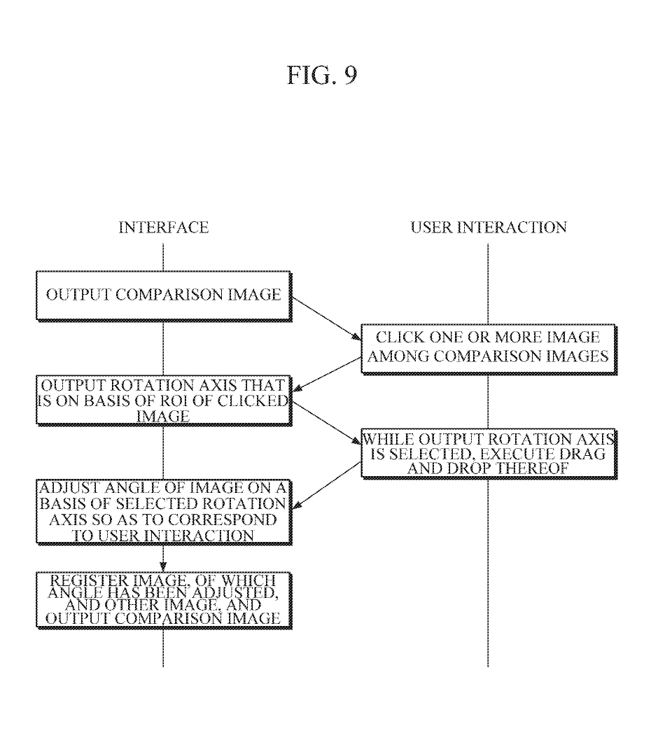

FIG. 9 is a diagram illustrating an example of, on an interface, receiving a user interaction and rotating a comparison image. An interface of a medical imaging apparatus 100 may provide rotation axes to a user so as to increase a user's convenience for the input.

Referring to FIG. 9, the medical imaging apparatus 100 outputs the comparison images to the interface. Here, the comparison images may be composed of two or more images. A user may input the interaction for clicking one or more images among the comparison images through interface

A user may, as the interaction, click one or more images among the comparison images through the interface.

The interface may accordingly output, to the interface, rotation axes that are based on the ROI included in the clicked image. For example, the medical imaging apparatus 100 may diagnose the comparison images to support the diagnosis of the ROI, detect the ROI, and find the center point of the ROI. The interface may output the rotation axes of x, y, and z on a basis of the center of the ROI.

Accordingly, while selecting one of the three rotation axes, which have been output to the interface, a user may execute the drag-and-drop thereof.

The interface may adjust the angle of the image on a basis of the selected rotation axis so as to correspond to the user interaction. Then, the interface may register the image, of which angle has been adjusted, and the other image, and output the comparison image.

The exemplary embodiment of changing one comparison image through the user interaction has been described above, however, this is limiting. For example, in a case the overlap degree of the ROIs to be reviewed is low in registering the two or more comparison images, the medical imaging apparatus 100 may be used to guide a user to move the comparison images so as to overlap the ROIs. Also, the medical imaging apparatus 100 may support a user to review the ROIs at various angles by registering the two or more comparison images and moving or rotating the entire image in any direction.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A medical imaging apparatus comprising:
a reference image processor configured to diagnose reference images acquired from first views;
a real-time image processor configured to diagnose a real-time image acquired from a second view different from the first views; and
an interface component configured to register two or more comparison images among the reference images and the real-time image as a combined comparison image, output the combined comparison image on a user interface, receive a user interaction input for analyzing the two or more comparison images, and process the two or more comparison images based on the received user interaction input.

2. The medical imaging apparatus of claim 1, wherein the interface component is configured to provide a reference setting window including an option screen area for selecting the two or more comparison images among the reference images and the real-time image, and register the two or more comparison images based on a user selection input received through the option screen area.

3. The medical imaging apparatus of claim 2, wherein the interface component is configured to provide, as a list of selection options on the option screen area, at least some images among the real-time image and the reference images that have a same region of interest (ROI) as an ROI acquired from the real-time image.

4. The medical imaging apparatus of claim 1, wherein the interface component is configured to automatically extract the two or more comparison images based on region of interests (ROIs) detected from the reference images and the real-time image, and register the two or more extracted comparison images.

5. The medical imaging apparatus of claim 1, wherein the interface component is configured to adjust and output at least one parameter among a location, an angle, and a transparency rate of the two or more comparison images, in response to receiving the user interaction input.

6. The medical imaging apparatus of claim 5, wherein the interface component is configured to provide a reference setting window including an output option screen area for setting at least one of the location, the angle, and the transparency rate for each of the two or more comparison images, and adjust and output at least one of the output location, the angle, and the transparency rate of the two or more comparison images, based on a user parameter setting input received through the output option screen area.

7. The medical imaging apparatus of claim 1, wherein the interface component is configured to output, on the user interface, a diagnosis result for at least one of the two or more comparison images, in response to receiving the user interaction input selecting the at least one of the two or more comparison images.

8. The medical imaging apparatus of claim 7, wherein the interface component is configured to provide a reference setting window including a diagnosis result option screen area,
the user interaction input selecting whether the diagnosis result with regard to each of the two or more comparison images is to be output is received via the diagnosis result option screen area, and
the interface component is configured to output the diagnosis result based on the user interaction input received through the diagnosis result option screen area.

9. The medical imaging apparatus of claim 7, wherein the interface component is configured to output the diagnosis result in response to receiving the user interaction input selecting the at least one of the two or more comparison images via an ultrasonic probe, and remove, from the user interface, the output diagnosis result in response to receiving the user interaction input deselecting the at least one of the two or more comparison images, for which the diagnosis result has been output.

10. The medical imaging apparatus of claim 1, wherein the interface component is configured to move, rotate, or remove at least one of the two or more comparison images included in the combined comparison image, in response to receiving the user interaction input, or add an additional image to the two or more comparison images included in the combined comparison image, in response to receiving the user interaction input.

11. The medical imaging apparatus of claim 10, wherein the interface component is configured to move or rotate at least one of the two or more comparison images to another location on a screen, while the at least one of the two or more comparison images is selected by a user input received via an ultrasonic probe.

12. The medical imaging apparatus of claim 10, wherein the interface component is configured to divide the screen of the user interface into first, second, and third areas, and to display the reference images on the first area, the real-time image on the second area, and the combined comparison image on the third area.

13. The medical imaging apparatus of claim 12, wherein the interface component is configured to:
in response to the user interaction input selecting at least one among the reference images displayed on the first area and the real time image displayed on the second area, add a selected image to the combined comparison image as the additional image, and move the selected image to the third area to be displayed in the combined comparison image; and
in response to another user interaction input selecting at least one among the two or more comparison images included into the combined comparison image displayed on the third area, remove the selected image from the third area, and move the selected image to be displayed on the first or second area, respectively.

14. A medical imaging method comprising:
diagnosing reference images acquired from first views;
diagnosing a real-time image acquired from a second view different from the first views;
registering two or more comparison images among the reference images and the real-time image as a combined comparison image;
outputting the combined comparison image on a user interface; and
processing the two or more comparison images based on a user interaction input for analyzing the two or more comparison images.

15. The medical imaging method of claim 14, wherein the processing comprises:
providing a reference setting window including an option screen area for selecting the two or more comparison images among the reference images and the real-time image;
registering the two or more comparison images based on a user selection input received through the option screen area; and
outputting the combined comparison image on the user interface.

16. The medical imaging method of claim 15, wherein the processing comprises:
providing, as a list of selection options on the option screen area, at least some images among the real-time image and the reference images that have a same region of interest (ROI) as an ROI acquired from the real-time image.

17. The medical imaging method of claim 14, wherein the registering comprises:
automatically extracting the two or more comparison images based on region of interests (ROIs) detected from the reference images and the real-time image; and
registering the two or more extracted comparison images.

18. The medical imaging method of claim 14, wherein the processing comprises:
adjusting and outputting at least one parameter among a location, an angle, and a transparency rate of the two or more comparison images, in response to the user interaction input.

19. The medical imaging method of claim 14, wherein the processing comprises:
outputting, on the user interface, a diagnosis result for at least one image among the two or more comparison images selected in response to the user interaction input.

20. The medical imaging method of claim 14, wherein the processing comprises:
moving, rotating, or removing at least one of the two or more comparison images included into the combined comparison image, in response to the user interaction input, or adding an additional image to the two or more comparison images included into the combined comparison image, in response to the user interaction input.
